(19) United States
(12) Patent Application Publication
(10) Pub. No.: US 2011/0162088 A1
(43) Pub. Date: Jun. 30, 2011

(54) COMMUNICATION TERMINAL APPARATUS AND METHOD OF CONTROLLING FUNCTION

(75) Inventors: Shigenori Masuda, Kawasaki (JP); Katsuaki Akama, Kawasaki (JP)

(73) Assignee: FUJITSU LIMITED, Kawasaki-shi (JP)

(21) Appl. No.: 12/823,480

(22) Filed: Jun. 25, 2010

(30) Foreign Application Priority Data
Dec. 25, 2009 (JP) 2009-295593

(51) Int. Cl. G06F 21/24

(52) U.S. Cl. 726/29

(57) ABSTRACT

A communication terminal apparatus for communicating data is disclosed, the communication terminal apparatus including a sending part configured to send, upon occurrence of an operation event, first identification data that identifies the communication terminal apparatus to another communication terminal apparatus which is in communication with the communication terminal apparatus; a receiving part configured to receive, from the another communication terminal apparatus, second identification data that identifies the another communication terminal apparatus; a memory part configured to store the first identification data upon occurrence of the operation event and the second identification data upon reception by the receiving part of the second identification data; and a controlling part configured to prevent an operation locally performed on the communication terminal apparatus from changing a setting of a function of the communication terminal apparatus while the second identification data is stored in the memory part.

### CROSS-REFERENCE TO RELATED APPLICATIONS

This application is based upon and claims the benefit of priority of Japanese Patent Application 2009-295593, filed on Dec. 25, 2009, the entire contents of which are incorporated herein by reference.

### FIELD

A certain aspect of the embodiments discussed herein is related to a communication terminal apparatus and a method of controlling a function.

### BACKGROUND

In recent years, a technology that improves security has been developed. For example, the technology restricts a function in a communication terminal apparatus or properly releases the functional restriction between communication terminal apparatuses that communicate mutually. For example, the functional restriction is the locking of a function of the communication terminal apparatus.

A technology describes that a mobile terminal stores a phone number for authentication for, when the mobile terminal is lost, and executes a lost process when the mobile terminal receives a call from the phone number that is stored for authentication and data that identifies a remote operation.

Another technology describes that a communication terminal apparatus restricts one or more functions when a distance between the communication terminal apparatus and a radio key is more than a predetermined distance. After the communication terminal apparatus restricts the function, the communication terminal apparatus releases the functional restriction when the distance between the communication terminal apparatus and the radio key is less than the predetermined distance.

### PATENT DOCUMENT

PATENT DOCUMENT 1: Japanese Laid-open Patent Publication No. 2002-368868

PATENT DOCUMENT 2: Japanese Laid-open Patent Publication NO. 2006-20003

### SUMMARY

In one aspect of the embodiments, there is a communication terminal apparatus for communicating data, the communication terminal apparatus including a sending part configured to send, upon occurrence of an operation event, first identification data that identifies the communication terminal apparatus to another communication terminal apparatus which is in communication with the communication terminal apparatus; a receiving part configured to receive, from the another communication terminal apparatus, second identification data that identifies the another communication terminal apparatus; a memory part configured to store the first identification data upon occurrence of the operation event and the second identification data upon reception by the receiving part of the second identification data; and a controlling part configured to prevent an operation locally performed on the communication terminal apparatus from changing a setting of a function of the communication terminal apparatus while the second identification data is stored in the memory part.

In another aspect of the embodiments, there is a method of controlling a function in a communication terminal apparatus, the method including sending, upon occurrence of an operation event, first identification data that identifies the communication terminal apparatus to another communication terminal apparatus which is in communication with the communication terminal apparatus; receiving from the another communication terminal apparatus second identification data that identifies the another communication terminal apparatus; storing the first identification data upon occurrence of an operation event and the second identification data upon reception by the receiving part of the second identification data; and preventing an operation locally performed on the communication terminal apparatus from changing a setting of a function of the communication terminal apparatus while the second identification data is stored.

The object and advantages of the embodiments will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF DRAWINGS

FIG. 1 illustrates one example of a separable mobile terminal;

FIG. 2 illustrates a block diagram of one example of hardware of a separable mobile terminal in the embodiments;

FIG. 3 illustrates a block diagram of one example of a function of a first apparatus and a second apparatus of a separable mobile terminal in an embodiment 1;

FIG. 4 explains one example of a process of updating identification data and a process of changing the setting in the embodiment 1;

FIG. 5 illustrates a flowchart of one example of a process of updating an identification that identifies an apparatus operated last;

FIG. 6 illustrates a flowchart of one example of a process of changing the setting;

FIG. 7 illustrates a block diagram of one example of a function of a first apparatus and a second apparatus of a separable mobile terminal in an embodiment 2;

FIG. 8 explains one example of a process of updating identification data and a process of a lock setting in the embodiment 2;

FIG. 9 illustrates a flowchart of one example of a process of a lock setting;

FIG. 10 illustrates a flowchart of one example of a process of an apparatus that releases a lock setting;

FIG. 11 illustrates one example of a code input display;

FIG. 12 illustrates a flowchart of one example of a process of an apparatus that receives a lock release code;

FIG. 13 illustrates a block diagram of one example of a function of a first apparatus and a second apparatus of a separable mobile terminal in an embodiment 3;

FIG. 14 illustrates a flowchart of one example of a process of a prohibition setting;

FIG. 15 illustrates a flowchart of one example of a release process of a prohibition setting of a second apparatus;

FIG. 16 illustrates one example of a release code input display of a prohibition setting; and

FIG. 17 illustrates a flowchart of one example of a release process of a prohibition setting of a first apparatus.

### DESCRIPTION OF EMBODIMENTS

Below, the embodiments will be described with reference to the figures.

### Embodiment 1

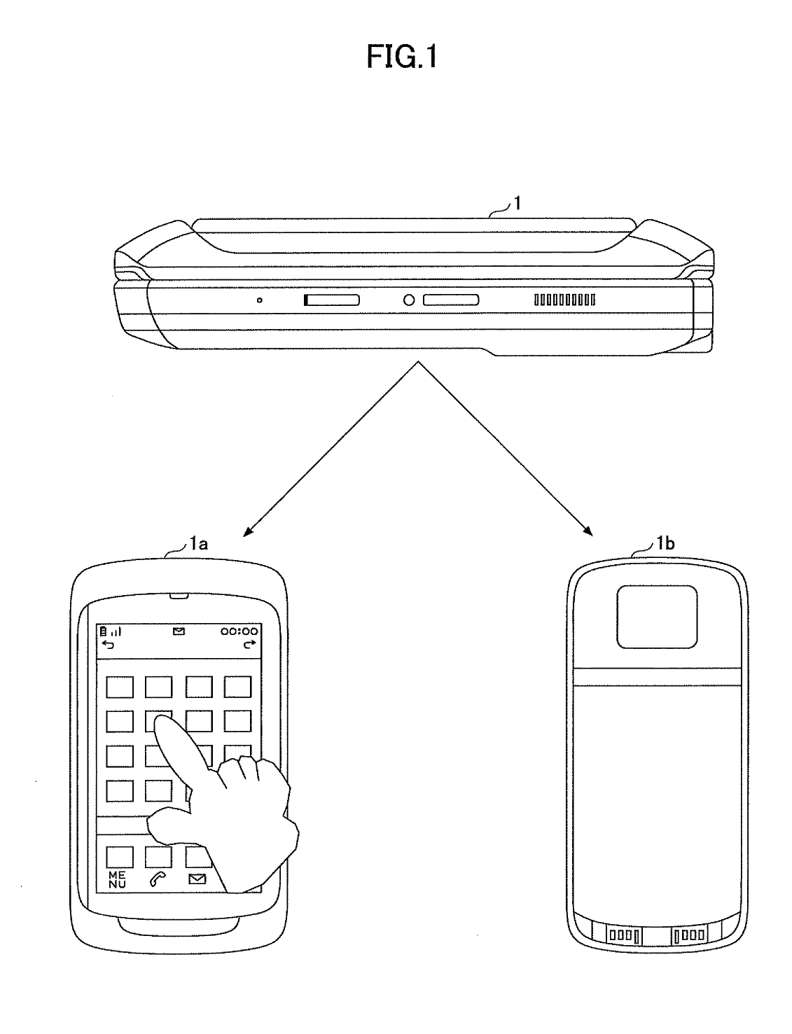

A communication terminal apparatus of the embodiments is in communication with another communication terminal apparatus mutually. The communication terminal apparatuses, for example, are a first apparatus and a second apparatus of a separable mobile terminal or a main apparatus and a sub apparatus of phone equipment, plural mobile terminals that are in communication mutually and so on. FIG. 1 illustrates one example of a separable mobile terminal. Below, the embodiments will be explained using one example of the separable mobile terminal as the communication terminal apparatuses that are in communication mutually; however the communication terminal apparatuses may be mobile terminals that are in communication mutually and so on.

The separable mobile terminal 1 separates into a first apparatus 1a and a second apparatus 1b as illustrated in FIG. 1. For example, the first apparatus 1a is a main apparatus and the second apparatus 1b is a sub apparatus. The first apparatus 1a and the second apparatus 1b are in communication mutually. A communication system between the first apparatus 1a and the second apparatus 1b is, for example, Bluetooth (registered trademark) and so on. The first apparatus 1a communicates by radio communication and may communicate image data and/or voice data. The second apparatus 1b communicates data with the first apparatus 1a and may communicate voice data through the first apparatus 1a.

The separable mobile terminal 1 in the embodiment 1 determines whether an apparatus operated last is the first apparatus 1a or the second apparatus 1b. The apparatus that is operated last controls one or more functions of the first apparatus 1a and/or the second apparatus 1b.

### <Hardware>

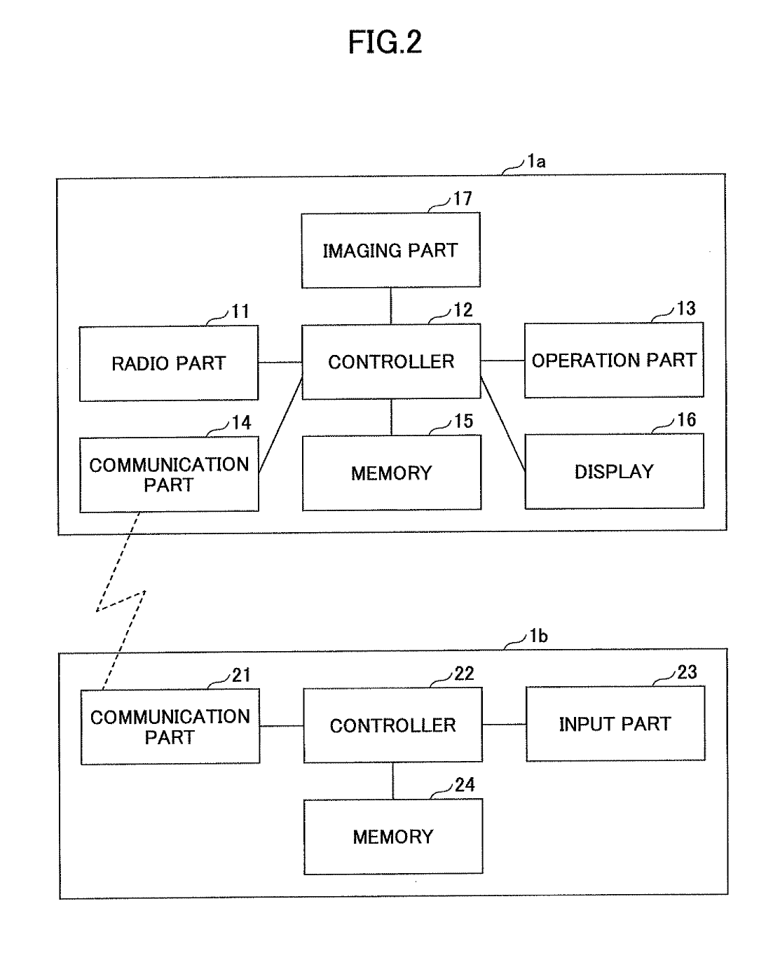

FIG. 2 illustrates a block diagram of one example of hardware of a separable mobile terminal in the embodiments. The first apparatus 1a of the separable mobile terminal 1 includes a radio part 11, a controller 12, an operation part 13, a communication part 14, a memory 15, a display 16 and an imaging part 17 as illustrated in FIG. 2.

The radio part 11 sends data to and receives data from a radio base station. The controller 12 is, for example, a CPU (Central Processing Unit), and controls each of the parts. The operation part 13 is, for example, a touch panel, and controls input data. The communication part 14 communicates by Bluetooth (registered trademark), and sends data to and receives data from a communication part 21 of the second apparatus 1b. The memory 15 stores programs and/or data of an application that is necessary for controlling the separable mobile terminal 1. The display 16 is a display device, for example, a LCD (Liquid Crystal Display). The imaging part 17 has a CCD, for example, a camera part.

The second apparatus 1b of the separable mobile terminal 1 includes the communication part 21, a controller 22, an input part 23 and a memory 24. The communication part 21 communicates by Bluetooth (registered trademark), and sends data to and receives data from the communication part 14 of the first apparatus 1a. The controller 22 is, for example, a CPU, and controls each of the parts. The input part 23 is, for example, a keyboard; a user inputs characters and selects data by using the keyboard. The memory 24 stores data and programs that control the second apparatus 1b. The above hardware is one embodiment and therefore the second apparatus 1b may include the imaging part 17 or the display 16.

### <Function>

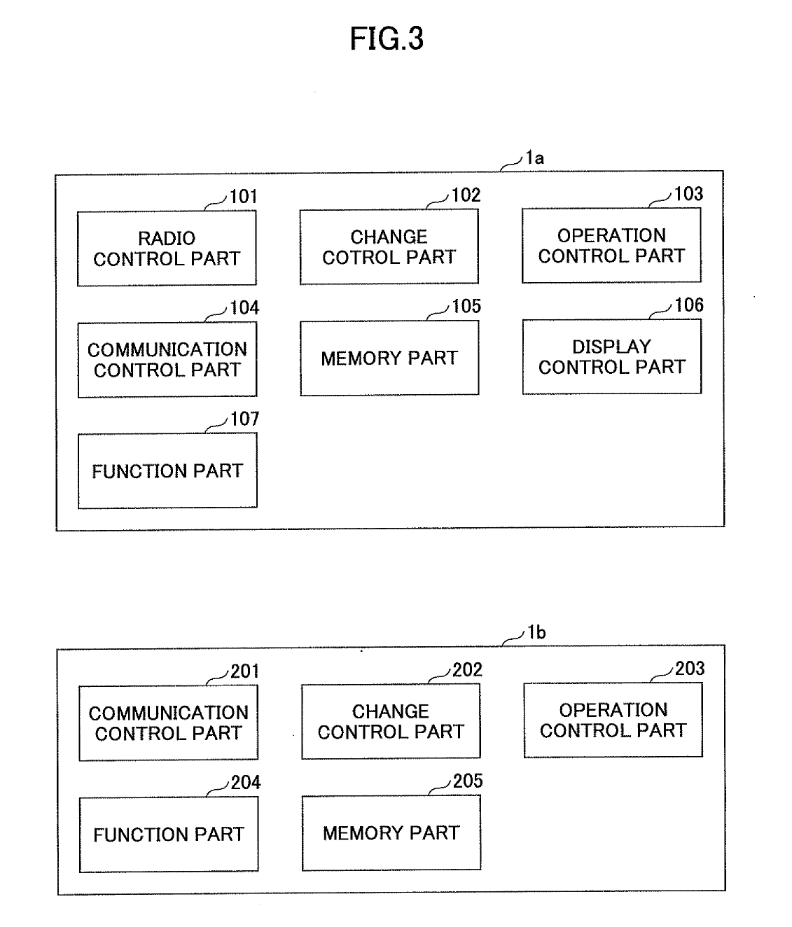

FIG. 3 illustrates a block diagram of one example of functions of a first apparatus and a second apparatus of a separable mobile terminal in an embodiment 1. The first apparatus 1a includes a radio control part 101, a change control part 102, an operation control part 103, a communication control part 104, a memory part 105, a display control part 106 and a function part 107 as illustrated in FIG. 3.

The radio control part 101 is realized by the radio part 11. The change control part 102, operation control part 103, display control part 106, and function part 107 are realized by the controller 12 and the memory 15. The communication control part 104 is realized by the communication part 14 or the controller 12. The memory part 105 is realized by the memory 15.

The radio control part 101 controls sending and/or receiving data by the radio part 11 of FIG. 2. The change control part 102 controls changes in the setting of a setting value of a function or a value that identifies whether it is possible to use the function. The change control part 102 permits changes in the setting from only an apparatus that is identified by identification data stored in a first memory area within the memory part 105.

The change control part 102 compares identification data of the first apparatus 1a with identification data stored in the first memory area, when the change control part 102 receives the change notice of the function from the operation control part 103. If a check result is in accord, the change control part 102 permits change of the function and instructs the communication control part 104 to send to the second apparatus 1b the identification data of the first apparatus 1a, information that identifies a changed function and information that identifies changed content. Here, function information is defined as information that identifies a function of a change object. Change information is identified as information that identifies a function of changed content.

The change control part 102 compares the identification data, the identification data being included in a change notice, with the identification data stored in the first memory area, when the change control part 102 receives the change notice of a function from the communication control part 104. If a check result is in accord, the change control part 102 permits change in the setting of the function that is identified by the function information, the function information being included in the change notice, based on the change content that is identified by the change information, the change information being included in the change notice. If the check result is not in accord, the change control part 102 prevents an operation locally performed on the first apparatus 1a from changing a setting of a function of the first apparatus 1a. For example, the first apparatus 1a does not change the own setting while the identification data of another apparatus is stored in the first memory area.

The operation control part 103 controls an operation of the operation part 13. When the operation control part 103 detects occurrence of an operation event in any function of the first apparatus 1a, the operation control part 103 writes the identification data of the first apparatus 1a in the first memory area within the memory part 105 and instructs the communication control part 104 to send to the second apparatus 1b the identification data of the first apparatus 1a.

When the communication control part 104 does not communicate, the operation control part 103 does not have to write in the first memory area even if the operation control part 104 detects the operation event of some function of the first apparatus 1a. Hereby, identification data stored in the first memory area and identification data stored in a second memory area within the second apparatus 1b are in accord because data stored in the first memory area does not need to be updated while the first apparatus 1a and the second apparatus 1b do not communicate mutually.

When the operation control part 103 detects the operation event about changing the setting of a function of the second apparatus 1b, the operation control part 103 sends to the change control part 102 a change notice including the function information and the change information given by a user.

The communication control part 104 communicates with a communication control part 201 of the second apparatus 1b. The communication control part 104 sends to the second apparatus 1b the identification data of the first apparatus 1a, when the communication control part 104 is instructed to send it to the second apparatus 1b by the operation control part 103. The communication control part 104 writes the identification data received from the second apparatus 1b in the first memory area within the memory part 105, when the communication control part 104 receives the identification data of the second apparatus 1b from the second apparatus 1b.

The communication control part 104 sends to the second apparatus 1b the change notice including the identification data of the first apparatus 1a and the function information and the change information, when the communication control part 104 is instructed to send the change command by the change control part 102. The communication control part 104 sends to the change control part 102 the received change notice, when the communication control part 104 receives the change notice from the second apparatus 1b.

The memory part 105 has the first memory area. The first memory area is an area that stores the identification data of an apparatus operated last between apparatuses that communicate mutually. The first memory area stores identification data that identifies own apparatus or identification data that identifies another apparatus. The identification data stored in the first memory area is updated every time the first apparatus 1a or the second apparatus 1b is operated by a user.

The display control part 106 controls display of picture data which is displayed on the display 16. The function part 107 controls an application executable by the first apparatus 1a. The application, for example, is a camera application, a mail application, a phone application, an Internet application and so on.

Next, functions of the second apparatus 1b will be described. The second apparatus 1b includes the communication control part 201, a change control part 202, an operation control part 203, a function part 204 and a memory part 205. The communication control part 201 is realized by the communication part 21 or the controller 22. The change control part 202, the operation control part 203, and the function part 204 are realized by the controller 22 and the memory 24. The memory part 205 is realized by the memory 24.

The communication control part 201 communicates with the communication control part 104 of the first apparatus 1a. The communication control part 201 sends to the first apparatus 1a the identification data of the second apparatus 1b, when the communication control part 201 is instructed to send it to the first apparatus 1a by the operation control part 203. The communication control part 201 writes the identification data that is received from the first apparatus 1a in the second memory area within the memory part 205, when the communication control part 201 receives the identification data of the first apparatus 1a from the first apparatus 1a.

The communication control part 201 sends to the first apparatus 1a a change notice including the identification data of the second apparatus 1b, the function information and the change information, when the change control part 202 instructs the communication control part 201 to send the change notice. The communication control part 201 sends to the change control part 202 the received change notice, when the communication control part 201 receives the change notice from the first apparatus 1a.

The change control part 202 controls changes in the setting of a setting value of a function including the function part 204 or a value that identifies authority to use the function. The change control part 202 permits a change in the setting from only an apparatus that is identified by identification data stored in the second memory area within the memory part 205.

The change control part 202 compares identification data of the second apparatus 1b with identification data stored in the second memory area, when the operation control part 203 instructs the change control part 202 to change the function. When a check result is in accord, the change control part 202 permits change of the function and instructs the communication control part 201 to send the identification data of the second apparatus 1b, information data that identifies the function which is changed, and the change information. When a check result is not in accord, the change control part 202 prevents a change in the setting of the function. For example, the second apparatus 1b does not prevent a change in the setting by the second apparatus 1b when identification data of the first apparatus 1a is stored in the second memory area.

The change control part 202 checks the identification data of the second apparatus 1b, the identification data being included in the change notice, with the identification data stored in the second memory area, when the change control part 202 receives the change notice of the function from the communication control part 201. When a check result is in accord, the change control part 202 permits a change in the setting of the function that is identified by the function information, the function information being included in the change notice, based on change content that is identified by the change information, the change information being included in the change notice.

The operation control part 203 controls an operation of the input part 23. When the operation control part 203 detects that the operation event occurs, the operation control part 203 writes the identification data of the second apparatus 1b in the second memory area within the memory part 205 and instructs the communication control part 201 to send the identification data of the second apparatus 1b to the first apparatus 1a. For example, the operation event is caused by the key operation.

When the communication control part 201 does not communicate with another apparatus, the operation control part 203 does not have to write in the second memory area even if the operation control part 203 detects an operation event. Hereby, identification data stored in the first memory area and identification data stored in the second memory area within the second apparatus 1b are in accord because information data stored in the second memory area does not need to be updated while the first apparatus 1a and the second apparatus 1b do not communicate mutually.

The operation control part 203 sends to the change control part 202 a change notice including the function information and the change information that are given by a user, when the operation control part 203 detects an operation event concerning change in the setting of a function of the first apparatus 1a.

The function part 204 controls an application that the second apparatus 1b may execute. The application is, for example, a lock function, a communication function, a camera function and so on.

The memory part 205 has the second memory area. The second memory area is an area that stores the identification data of an apparatus operated last between apparatuses that communicate mutually. The identification data stored in the second memory area is updated every time the first apparatus 1a or the second apparatus 1b is operated by a user.

The first memory area within the memory part 105 and the second memory area within the memory part 205 store same identification data. An apparatus that is identified by the same identification data identifies an apparatus operated last between the first apparatus 1a and the second apparatus 1b.

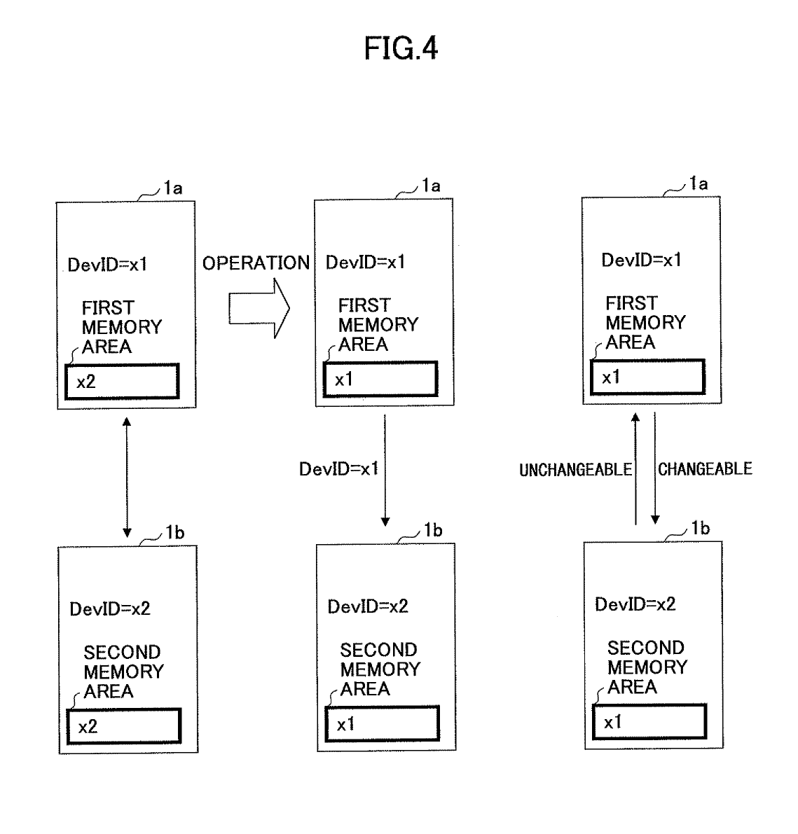

FIG. 4 explains one example of a process of updating identification data and a process of changing the setting in an embodiment 1. The first apparatus 1a and the second apparatus 1b communicate mutually as illustrated in a left part of FIG. 4. The identification data of the first apparatus 1a is, for example, “x1”. Below, the identification data is also called “DevID (DevID means Device ID)”. The first memory area stores the identification data of an apparatus that is operated last. Here, the first memory area has stored DevID “x2”.

The identification data of the second apparatus 1b is, for example, “x2”. In this case, the second apparatus 1b is an apparatus that is operated last between the first apparatus 1a and the second apparatus 1b, and DevID “x2” of the second apparatus 1b is stored in the first memory area and the second memory area.

In a center part of FIG. 4, a process of sending DevID, when the first apparatus 1a is operated, will be described. When a user operates the first apparatus 1a, the operation control part 103 detects the operation event and writes or overwrites DevID “x1” of the first apparatus 1a in the first memory area. Then the operation control part 103 instructs the communication control part 104 to send the DevID “x1”. When the communication control part 104 receives a sending instruction from the operation control part 103, the communication control part 104 sends DevID “x1” to the second apparatus 1b.

When the communication control part 201 of the second apparatus 1b receives DevID “x1” from the first apparatus 1a, the communication control part 201 instructs writing or overwriting DevID “x1” in the second memory area. Hereby, the identification data stored in the first memory area and the identification data stored in the second memory area are the same identification data as illustrated in FIG. 4. The first apparatus 1a and the second apparatus 1b are able to determine that the first apparatus 1a is an apparatus that is operated last between the first apparatus 1a and the second apparatus 1b.

In a right part of FIG. 4, one example of a change in the setting at the first apparatus 1a and the second apparatus 1b will be described. For example, the first apparatus 1a tries to change the setting of an arbitrary function of the second apparatus 1b. The change control part 102 compares DevID “x1” of own apparatus with the DevID stored in the first memory area. In this case, the change control part 102 instructs the communication control part 104 to change the setting of the second apparatus 1b because a check result is in accord.

The communication control part 104 sends to the second apparatus 1b a change notice. The change notice includes the function information, the change information, the DevID and so on. Next, the second apparatus 1b tries to change the setting of the arbitrary function of the second apparatus 1b. The change control part 202 of the second apparatus 1b compares DevID “x2” of own apparatus with the DevID stored in the second memory area. In this case, the change control part 202 does not permit changing the setting sent from the first apparatus 1a because a check result is not in accord. The change control part 202 may prevent an operation locally performed on the second apparatus 1b from changing a setting of a function of the second apparatus 1b because the check result is not in accord.

The operation control part 103 of the first apparatus 1a and the operation control part 203 of the second apparatus 1b do not detect the operation event which is detected to update the identification data stored in the first or second memory area if a function of each apparatus is restricted. For example, a functional restriction is a lock of the apparatus. If the operation event to update the identification data is an input event to input a release code of security, the operation event may not be detected when the authentication of the release code fails. The operation event to update the identification data may be detected only when pressing the key is executed more than a prescribed frequency in a prescribed time period. The operation event to update the identification data may be detected only when the operation event is an operation event set beforehand. Hereby, it prevents updating the identification data, which is stored in the first memory area or the second memory area, by a wrong operation that a user does not intend. The wrong operation is, for example, pressing the key by an object within a bag when the first apparatus 1a and/or the second apparatus 1b is within the bag. As for the detection of the operation event to update the identification, the below embodiments are similar to the above-mentioned description.

### <Operation>

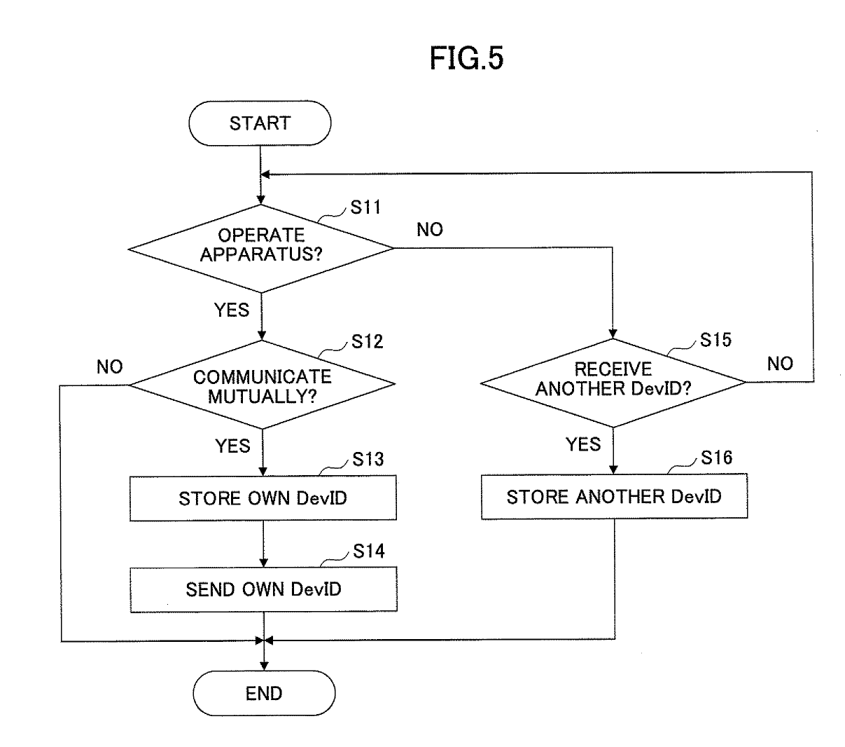

Next, a process of updating the memory area and a process of changing the setting in the first apparatus 1a or the second apparatus 1b will be described. FIG. 5 illustrates a flowchart of one example of a process of updating an identification that identifies an apparatus operated last. Below, one example of the first apparatus 1a will be described. The second apparatus 1b executes a process similar to that of the first apparatus 1a.

In step S11, the operation control part 103 carries out detection of a occurrence of an operation event. When the operation control part 103 detects the operation event, step S12 is proceeded to. When the operation control part 103 does not detect the operation event, step S15 is proceeded to.

In step S12, the communication control part 104 determines whether the communication control part 104 is able to communicate with the communication control part 201 of the second apparatus 1b mutually. For example, the first apparatus 1a and the second apparatus 1b do not communicate mutually, when a distance between these apparatuses is more than a predetermined distance. When these apparatuses may communicate mutually, step S13 is proceeded to. When these apparatuses do not communicate mutually, this process is ended.

In step S13, the operation control part 103 writes or overwrites DevID of own apparatus in the first memory area, when the communication control part 104 determines that the communication control part 104 may communicate with the communication control part 201.

In step S14, the communication control part 104 sends to the second apparatus 1b DevID “x1” of own apparatus.

In step S15, the communication control part 104 determines whether the communication control part 104 has received the DevID of the second apparatus 1b. When the communication control part 104 has received the DevID of the second apparatus 1b, step S16 is proceeded to. When the communication control part 104 has not received the DevID of the second apparatus 1b, step S11 is returned to.

In step S16, the communication control part 104 writes or overwrites the received DevID of the second apparatus 1b in the first memory area. Hereby, the first apparatus 1a and the second apparatus 1b determine an apparatus that is operated last by respectively referring to the first and the second memory areas.

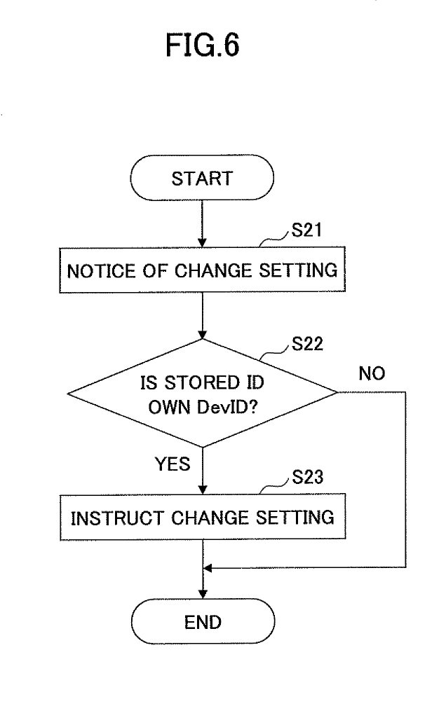

FIG. 6 illustrates a flowchart of one example of a process of changing the setting. Below, one example of the first apparatus 1a will be described. The second apparatus 1b executes a process similar to that of the first apparatus 1a.

In step S21, the change control part 102 is notified by the operation control part 103 that an operation event of a setting change has occurred.

In step S22, the change control part 102 compares the DevID of own apparatus with the DevID stored in the first memory area. When a check result is in accord, step S23 is proceeded to. When a check result is not in accord, this process is ended.

In step S23, the change control part 102 outputs to the communication control part 103 an instruction of setting change to change the setting of a function of the second apparatus 1b. Therefore, the communication control part 104 sends to the second apparatus 1b a change notice of the function, and the second apparatus 1b changes the setting of the function based on the change notice. Hereby, an apparatus does not change the setting of another apparatus when the apparatus is not an apparatus that is operated last.

The first apparatus 1a may determine whether the first apparatus 1a is an apparatus which is operated last at the time of not only a change in the setting of the second apparatus 1b but also a change in the setting of the first apparatus 1a.

In the embodiment 1, it is possible to change the settings of some functions of each apparatus from an apparatus that is operated last. Hereby, the level of the security is increased. An apparatus that executes a change in the setting does not execute the change in the setting of own apparatus or another apparatus if the apparatus is not the apparatus that is operated last.

Below, another method of determining that the apparatus is operated last will be described. For example, a memory area of own apparatus stores the identification data of another apparatus when the identification data of the other apparatus is received, and the identification data that is stored in the memory area is deleted when own apparatus is operated. Hereby, each apparatus may determine that the other apparatus is the apparatus which is operated last if there is the identification data in the memory area, and each apparatus may determine that the own apparatus is an apparatus which is operated last if there is not the identification data in the memory area.

If the number of apparatuses that communicate mutually is two, an apparatus may identify another apparatus. Therefore, the apparatus may store data in the memory area, the data identifying that the apparatus receives the identification data (DevID), when the identification data of the other apparatus is received. The data is, for example, a mark, a flag and so on. In this case, the apparatus deletes the identification data of the other apparatus or the data, which identifies that the apparatus has received the identification data, when the operation event occurs at the own apparatus. Hereby, each apparatus may determine that the other apparatus is the apparatus which is operated last if there is the identification data of the other apparatus or the data, which identifies that the apparatus has received the identification data, in the memory area and each apparatus may determine that own apparatus is the apparatus which is operated last if there is nothing in the memory area.

### Embodiment 2

Next, a separable mobile terminal of an embodiment 2 will be described. In the embodiment 2, an apparatus which is operated last may release the lock of the apparatus. For example, a communication terminal apparatus locks or releases the lock independently, in the case where it is assumed that the apparatus that has not been used is stolen. If the lost apparatus is released from a lock setting, the lost apparatus may be used freely. Therefore, the lost apparatus has the lock setting released by the apparatus that is operated last. This is based on the following idea. The likelihood is high that a user has the apparatus which is operated last. The likelihood is high that the apparatus which has not been used is stolen.

### <Function>

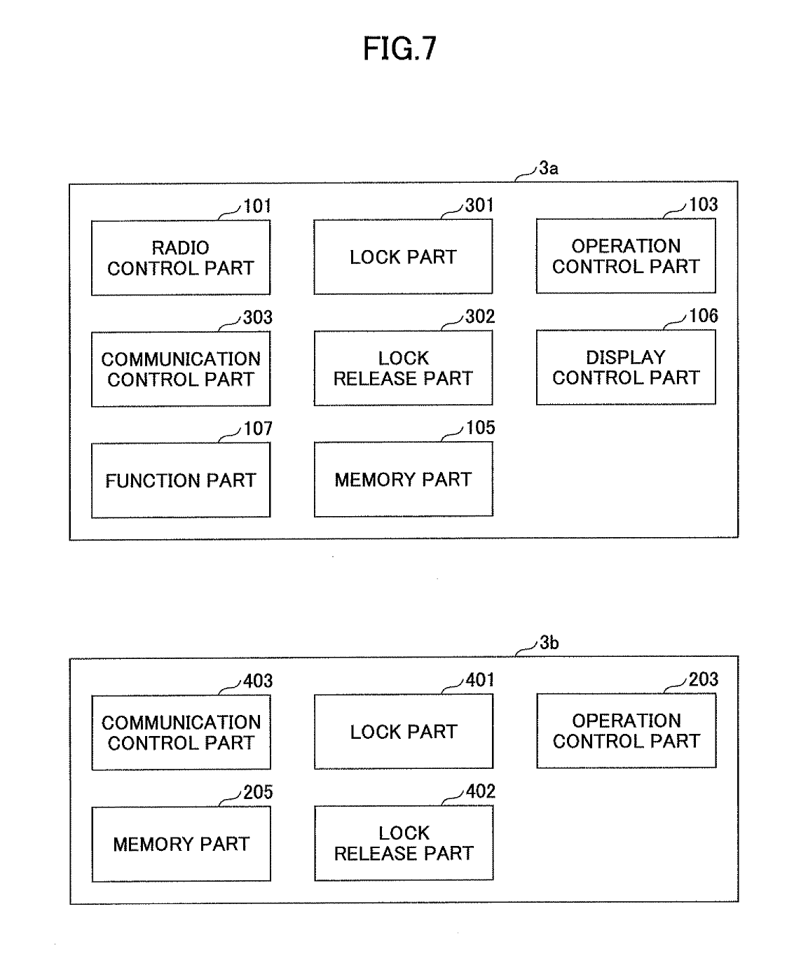

FIG. 7 illustrates a block diagram of one example of a function of a first apparatus and a second apparatus of a separable mobile terminal in the embodiment 2. Functions other than those of a lock part 301, a lock release part 302, a communication control part 303, a lock part 401, a lock release part 402 and a communication control part 403 are the same as those illustrated in FIG. 3. The lock part 301, the communication control part 303, and the lock release part 302 are realized by the controller 12 and the memory 15. The communication control part 403, the lock part 401, and the lock release part 402 are realized by the controller 22 and the memory 24.

The lock part 301 of the first apparatus 3a, which is illustrated in FIG. 7, restricts a function of the first apparatus 3a when a prescribed requirement is met. Below, the functional restriction is also called the lock. The prescribed requirement is that, for example, the first apparatus 3a has not operated at least for a prescribed time, a distance between the first apparatus 3a and the second apparatus 3b is more than a prescribed distance, the lock setting is done from another apparatus by remote control and so on. Here, the prescribed requirement is that the first apparatus 3a has not operated at least for a prescribed time.

The lock release part 302 of the first apparatus 3a includes a function of releasing the lock setting by the lock part 301. The lock release part 302 determines whether the apparatus, which is operated last, carries out an operation of the lock release. The lock release part 302 compares identification data of own apparatus with identification data stored in a first memory area, when the first apparatus 3a executes an operation of a lock release process. If a check result is in accord, the lock release part 302 determines that the first apparatus 3a is the apparatus which is operated last, and executes a process of the lock release. Then the lock release part 302 instructs a communication control part 303 to send a notice of the lock release to the second apparatus 3b. If the check result is not in accord, the lock release part 302 prevents a process of the lock release in the first apparatus 3a.

The process of the lock release is an authentication process of checking a code number, biometric authentication and so on. Below, an authentication process as one example of checking the password will be described. The operation control part 103 detects the inputted password.

When the lock release part 302 receives the notice of the lock release from the communication control part 303, the lock release part 302 compares identification data, the identification data being included in the notice of the lock release, with identification data stored in the first memory area. When a check result is in accord, the lock release part 302 executes a process of the lock release by password. The password is included in the notice of the lock release.

When the communication control part 303 receives a sending instruction from the lock release part 302, the communication control part 303 sends a notice of the lock release including the identification data that identifies the first apparatus 3a, and the password to the second apparatus 3b.

When the communication control part 303 receives the notice of the lock release from the second apparatus 3b, the communication control part 303 outputs the notice of the lock release to the lock release part 302.

A lock part 401 of the second apparatus 3b, which is illustrated in FIG. 7, restricts a function of the second apparatus 3b when a prescribed requirement is met. The prescribed requirement is that, for example, the second apparatus 3b has not operated at least for a prescribed time, a distance between the second apparatus 3b and the first apparatus 3a is more than a prescribed distance, the lock setting is done from another apparatus by remote control and so on. Here, the prescribed requirement is, for example, that the second apparatus 3b has not operated at least for a prescribed time as well as the first apparatus 3a.

The lock release part 402 of the second apparatus 3b includes a lock release function by the lock part 401. The lock release part 402 determines whether an apparatus, which is operated last, carries out an operation of the lock release. The lock release part 402 compares identification data of own apparatus with identification data stored in a second memory area, when the second apparatus 3b executes an operation of the lock release process. When a check result is in accord, the lock release part 402 determines that the second apparatus 3b is the apparatus which is operated last and executes a process of the lock release. Then the lock release part 402 instructs a communication control part 403 to send a notice of the lock release to the first apparatus 3a. When a check result is not in accord, the lock release part 402 prevents a process of the lock release by the second apparatus 3b.

When the lock release part 402 receives the notice of the lock release from the communication control part 403, the lock release part 402 compares identification data, the identification data being included in the notice of the lock release with identification data stored in the second memory area. When a check result is in accord, the lock release part 402 executes a process of the lock release by password. The password is included in the notice of the lock release.

When the communication control part 403 receives a sending instruction from the lock release part 402, the communication control part 403 sends to the first apparatus 3a a notice of the lock release. When the communication control part 403 receives the notice of the lock release from the first apparatus 3a, the communication control part 403 outputs the notice of the lock release to the lock release part 402.

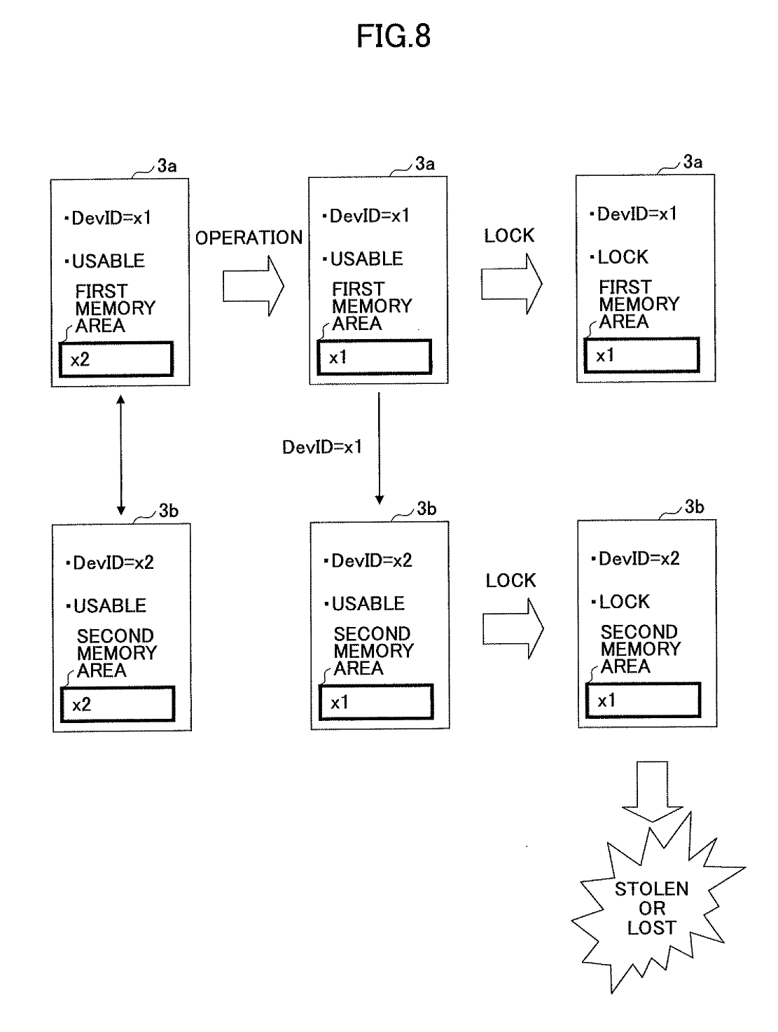

FIG. 8 explains one example of a process of updating identification data and a process of the lock setting in the embodiment 2. The first apparatus 3a and the second apparatus 3b communicate mutually as illustrated in a left part of FIG. 8. The identification data of the first apparatus 3a is, for example, “x1”. For example, the first memory area has stored DevID “x2” now. The first memory area stores the identification data of an apparatus that is operated last. The first apparatus 3a is in a status of free use because the first apparatus 3a is not locked now.

The identification data of the second apparatus 3b is, for example, “x2”. DevID “x2” is stored in a second memory area that stores the identification data of the apparatus that is operated last. In this case, the second apparatus 3b is an apparatus that is operated last between the first apparatus 3a and the second apparatus 3b, and the DevID of the second apparatus 3b is stored in the first memory area and the second memory area.

A process of sending DevID “x1”, when the first apparatus 3a is operated, will be described using a center part of FIG. 8. When a user operates the first apparatus 3a, the operation control part 103 detects the operation event and writes or overwrites DevID “x1” of the first apparatus 3a in the first memory area. Then the operation control part 103 instructs the communication control part 303 to send the DevID “x1”. When the communication control part 303 receives a sending instruction from the operation control part 103, the communication control part 303 sends DevID “x1” to the second apparatus 3b.

When the communication control part 403 of the second apparatus 3b receives DevID “x1” from the first apparatus 3a, the communication control part 403 writes or overwrites DevID “x1” in the second memory area. Hereby, the identification data stored in the first memory area and the identification data stored in the second memory area are the same identification data as illustrated in a center of FIG. 8. The first apparatus 3a and the second apparatus 3b are able to determine that the first apparatus 3a is the apparatus that is operated last between the first apparatus 3a and the second apparatus 3b.

One example of the lock setting at the first apparatus 3a and the second apparatus 3b will be described as illustrated in a right part of FIG. 8. For example, the first apparatus 3a and the second apparatus 3b have not been operated for a predetermined time, and these apparatuses have done the lock setting. Hereby, if the locked second apparatus 3b is stolen or lost, the lock setting of the second apparatus 3b is not released using only the second apparatus 3b because the identification data that is stored in the second memory area identifies another apparatus.

### <Operation>

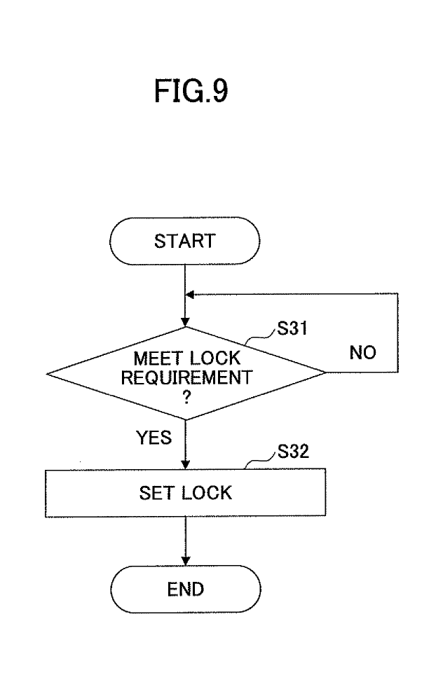

FIG. 9 illustrates a flowchart of one example of a process of the lock setting. Below, one example of the first apparatus 3a will be described. The lock part 410 of the second apparatus 3b executes a process similar to that of the lock part 301 of the first apparatus 3a.

In step S31, the lock part 301 determines whether a lock requirement is met. The lock requirement is, for example, passing a predetermined time or that the distance between the first apparatus 3a and the second apparatus 3b is more than a predetermined distance. When the lock requirement is met, step S32 is proceeded to. When the lock requirement is not met, step S31 is returned to.

In step S32, the lock part 301 locks a function of the first apparatus 3a. Then the lock part 301 sets to permit release of the lock setting from only an apparatus that is identified by the identification data stored in the first memory area. When the lock part 301 locks the function, the lock part 301 may lock all functions or some functions. Some functions may be preset by the user.

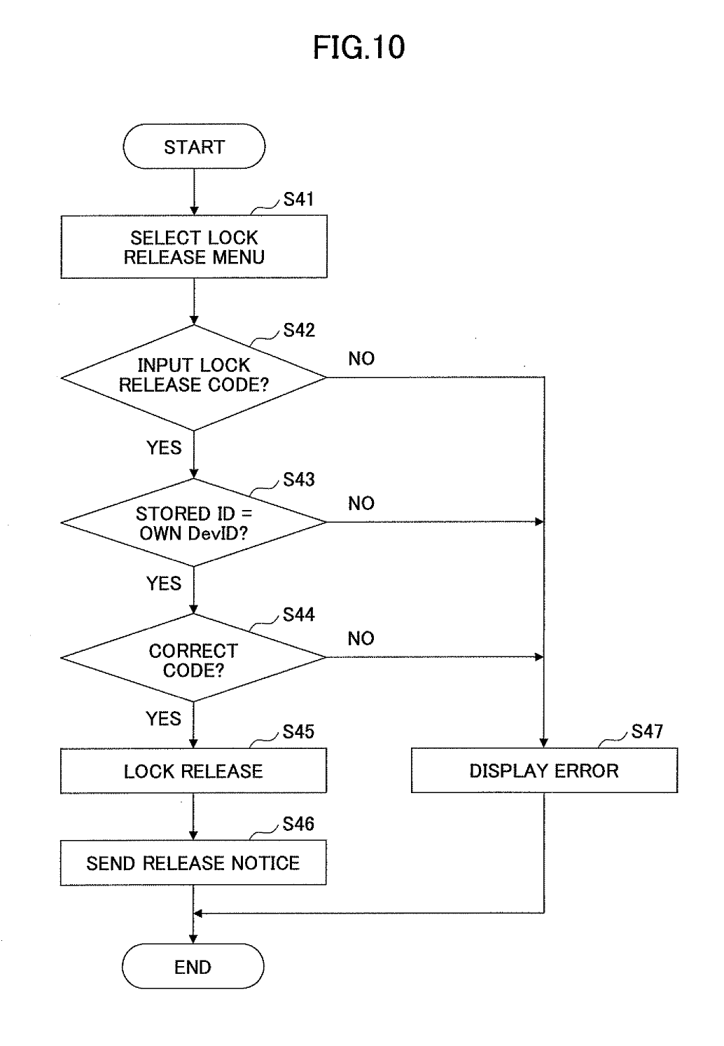

FIG. 10 illustrates a flowchart of one example of a process of an apparatus that releases the lock setting. Below, one example of the first apparatus 3a as an apparatus that releases the lock setting will be described. The second apparatus 3b executes a process similar to that of the first apparatus 3a.

In step S41, the operation control part 103 detects that the lock release menu is selected by the user.

In step S42, the operation control part 103 determines whether the user has inputted the code to release the lock setting. The code is, for example, some numbers or an alphanumeric string. When the code has been inputted, step S43 is proceeded to. When the code has not been inputted for a predetermined time, step S47 is proceeded to. For example, when the code has not been inputted for a predetermined time, it is processed as a timeout.

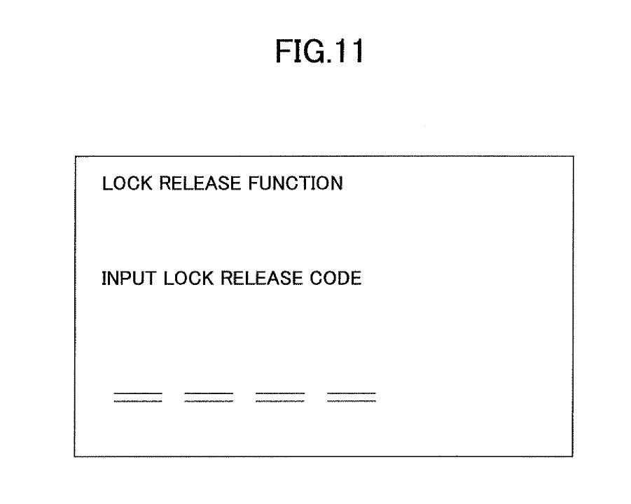

FIG. 11 illustrates one example of a code input display. The example illustrated in FIG. 11 is one example of carrying out the lock release by code number. The display illustrated in FIG. 11 is displayed at the display 16, and four figures of a code number are inputted by the user. The operation control part 103 sends to the lock release part 302 the inputted code number.

In step S43, the lock release part 302 compares the identification stored in the first memory area with the identification data of own apparatus when the lock release part 302 receives from the operation control part 103 the inputted code number. When a check result is in accord, step S44 is proceeded to. When the check result is not in accord, step S47 is proceeded to.

In step S44, the lock release part 302 determines whether the inputted code number is correct. The lock release part 302 stores the correct code number. The inputted code number is, for example, some numbers or an alphanumeric string and so on. When the inputted code number is correct, step S45 is proceeded to. When the inputted code number is not correct, step S47 is proceeded to.

In step S45, the lock release part 302 releases the lock setting of own apparatus. In step S46, the communication control part 303 sends to the second apparatus 3b the notice of the lock release including the code number and the identification data of own apparatus when the communication control part 303 receives from the lock release part 302 the sending instruction to send the code number and the identification data of own apparatus.

In step S47, the display control part 106 displays error on the display 16. The second apparatus 3b signals error by a sound if the second apparatus 3b does not have the display when the second apparatus 3b carries out release of the lock setting.

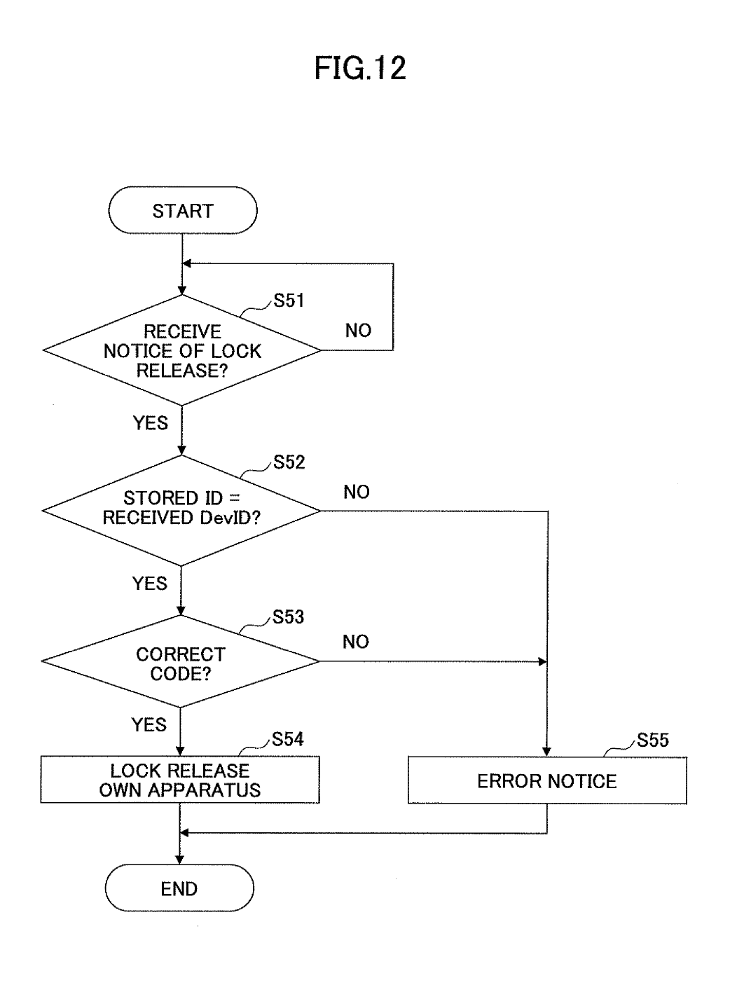

FIG. 12 illustrates a flowchart of one example of a process of an apparatus that receives a lock release code. Below, one example of the second apparatus 3b will be described. The first apparatus 3a executes a process similar to that of the second apparatus 3b.

In step S51, the communication control part 403 determines whether the communication control part 403 has received from the first apparatus 3a the notice of the lock release including the identification data of the apparatus and the code number. When the communication control part 403 has received the notice of the lock release, step S52 is proceeded to. When the communication control part 403 has not received the notice of the lock release, step S51 is returned to. The communication control part 403 outputs to the lock release part 402 the received notice of the lock release.

In step S52, the lock release part 402 compares the received identification data with the identification data stored in the second memory area. When a check result is in accord, step S53 is proceeded to. When a check result is not in accord, step S55 is proceeded to.

In step S53, the lock release part 402 determines whether the received code number is correct. The lock release part 402 stores a correct code number. When the received code number is correct, step S54 is proceeded to. When the received code number is not correct, step S55 is proceeded to.

In step S54, the lock release part 402 releases the lock setting of own apparatus. In step S55, the second apparatus 3b displays error if the second apparatus 3b has a display. The second apparatus 3b signals error by a sound if the second apparatus 3b does not have the display.

In FIGS. 10 and 12, the apparatus that releases the lock setting and the apparatus that receives the code number are described separately. However, the first apparatus 3a and the second apparatus 3b carry out the process of FIGS. 10 and 12 actually. Therefore, each apparatus carries out a determination whether a lock release menu is selected by a user after S51 of FIG. 12. When the lock release menu is selected, the processes after step S42 of FIG. 10 are carried out. When the lock release menu is not selected, step S51 is returned to.

In the embodiment 2, the apparatus which is operated last is able to release the lock setting of the apparatus. If a memory area of an apparatus stores identification data that identifies another apparatus, the apparatus does not release the lock setting of the apparatus. Hereby, when an apparatus which has not operated is locked by timeout, even if the apparatus is stolen, it is not necessary to worry whether the lock setting will be released. This embodiment is useful when one of the apparatuses that communicate mutually is stolen or left. The apparatuses are, for example, a first and a second mobile terminal of a separable mobile terminal.

### Embodiment 3

Next, a separable mobile terminal in the embodiment 3 will be described. In an embodiment 3, an operation of another apparatus has added a requirement of functional restriction. Hereby, the identification data, which is stored in a memory area, is the identification data of another apparatus when a function of the apparatus is restricted. For example, one of requirements to prevent a camera function of a main apparatus is an operation of a sub apparatus. In this case, the camera function of the main apparatus is prevented by the operation of the sub apparatus. Hereby, the camera function of the main apparatus is not used by another person even if the main apparatus is lost or left. In the area of the camera use prevention, this embodiment is useful when only the sub apparatus is carried and the main apparatus that includes the camera function is left at the entrance.

### <Function>

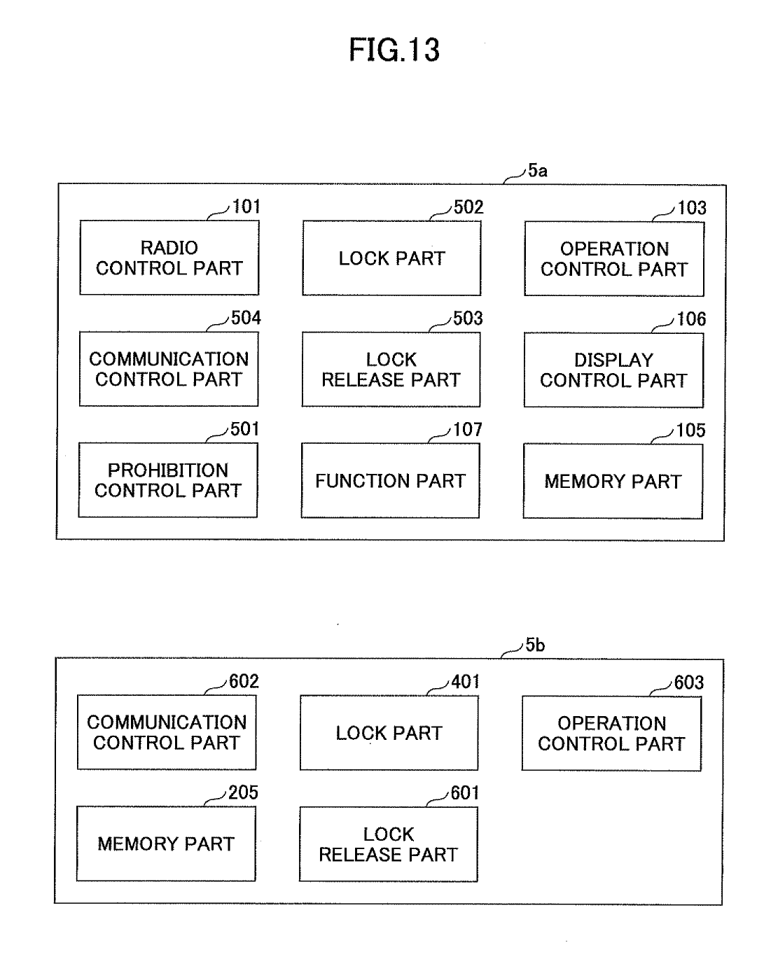

FIG. 13 illustrates a block diagram of one example of a function of a first apparatus and a second apparatus of a separable mobile terminal in the embodiment 3. Functions other than those of a prohibition control part 501, a lock part 502, a lock release part 503, a communication control part 504, a lock release part 601, a communication control part 602 and an operation control part 603 are the same as those illustrated in FIGS. 2 and 7. One example that is illustrated in FIG. 13 is a case whether one of the requirements to prevent using the camera function of the first apparatus 5a is an operation of the second apparatus 5b. The second apparatus 5b may have the above function. The lock part 502, the communication control part 504, the lock release part 503, and the prohibition control part 501 are realized by the controller 12 and memory 15. The communication control part 602, the operation control part 603, and the lock release part 601 are realized by the controller 22 and the memory 24.

The prohibition control part 501 sends to the lock part 502 function information that is selected by the user, or is preset. The function information identifies a function to be set with a prohibition setting.

The lock part 502 determines whether the lock part 502 has received the identification data from the communication control part 504 when the lock part 502 has received the function information from the prevention control part 501. The lock part 502 locks the function that is represented by the function information, when the lock part 502 has received the identification data of an apparatus from the communication control part 504. Then, the lock part 502 sets an apparatus that is identified by the identification data stored in the first memory area as an apparatus that may release the lock of the function. The first memory area has been updated with the identification data that the communication control part 504 received. Hereby, the identification data stored in the first memory area is the second identification data.

The lock release part 503 executes a release process using the identification data of the apparatus and a release code, when the lock release part 503 has received the release notice of the prohibition setting from the communication control part 504. The release notice of the prohibition setting includes the identification data of the apparatus, the release code and information that identifies the release of the prohibition setting. The information that identified the release of the prohibition setting is defined as prohibition release information. The prohibition release information is necessary to distinguish from a usual lock release in an embodiment 2. The lock release part 503 releases the prohibition setting, when a check result of the identification data is in accord and authentication of the release code succeeds.

The communication control part 504 sends to the lock release part 503 the release notice of the prohibition setting when the communication control part 504 receives the release notice of the prohibition setting from the second apparatus 5b. Functions other than those of the communication control part 504 are similar to those of the above embodiments.

The lock release part 601 of the second apparatus 5b sends to the communication control part 602 the release code and the prohibition release information that are received from the operation control part 603 when the operation control part 603 detects that a prohibition setting release menu is selected by a user and the release code and the prohibition release information are inputted by the user.

The communication control part 602 sends to the first apparatus 5a the release notice of the prohibition setting including the release code, the prohibition release information and the identification data of the second apparatus 5b when the communication control part 602 receives the release code and the prohibition release information from the lock release part 601.

The operation control part 603 may select the prohibition setting release menu by selection of a user. The operation control part 603 sends to the lock release part 601 the release code of the prohibition setting that is inputted from the prohibition setting release menu by a user when the prohibition setting release menu is selected by the user.

### <Operation>

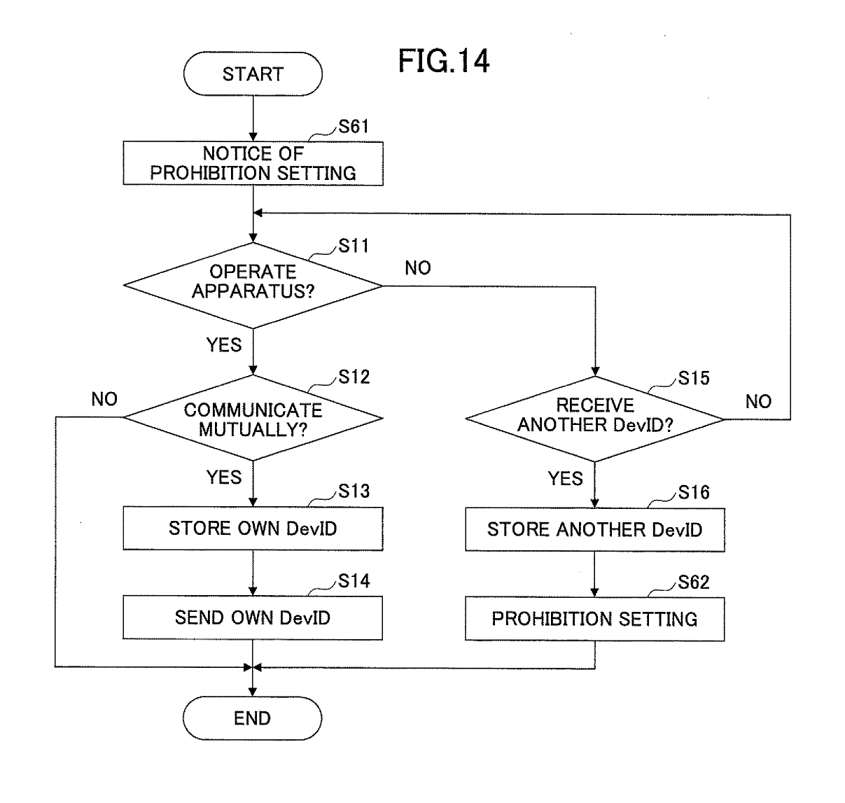

FIG. 14 illustrates a flowchart of one example of a process of prohibition setting. Processes other than those of S61 and are the same as those illustrated in FIG. 5.

In step S61, the prohibition control part 501 notifies the lock part 502 of a function of prohibition setting. For example, a function of prohibition setting is a camera function, an Internet function, a telephone function or all functions of the first apparatus 5a and so on.

In step S62, the lock part 502 carries out the lock setting after the identification data of another apparatus has been stored in the first memory area. The other apparatus is, for example, the second apparatus 5b. The lock part 502 sets an apparatus that is identified by the identification data stored in the first memory area as an apparatus that releases a prohibition setting, when the lock part 502 carries out the prohibition setting of the camera function. Hereby, a release requirement is set to carry out the lock release from only another apparatus because the release requirement is an operation of another apparatus. The separable mobile terminal 5 sets the prohibition setting before separation and may execute a function of the prohibition setting automatically after separation. The separable mobile terminal 5 may set the prohibition setting by operation after separation.

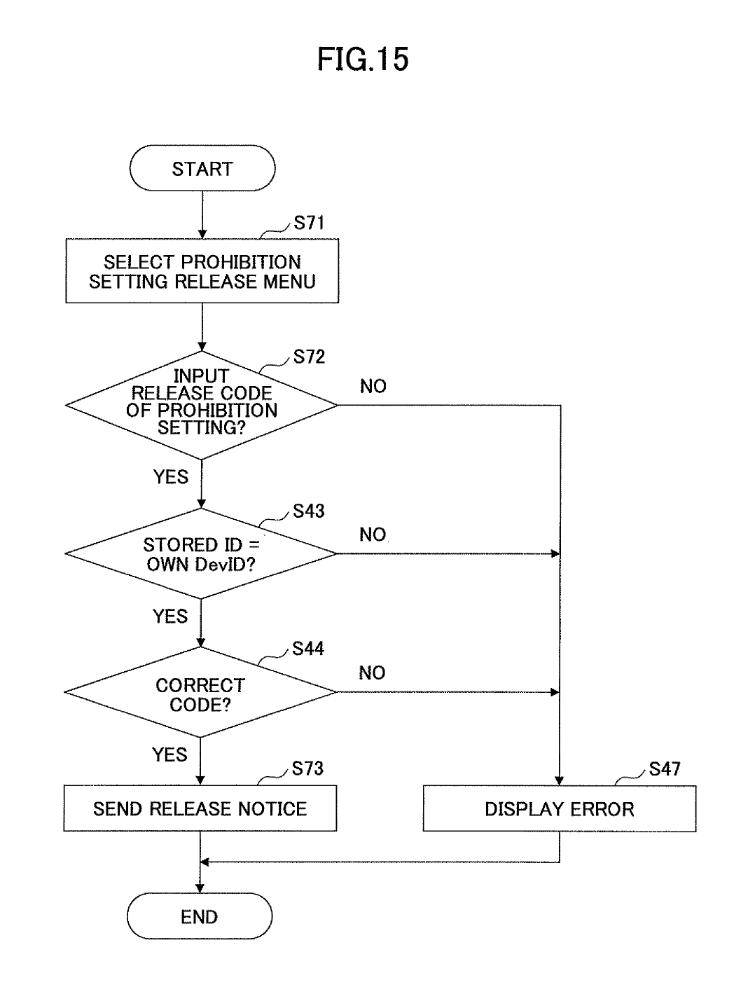

FIG. 15 illustrates a flowchart of one example of a release process of prohibition setting of a second apparatus. Processes other than S71, S72 and S73 are the same as those illustrated in FIG. 10.

In step S71, the operation control part 603 detects that the prohibition release menu is selected by a user.

In step S72, the operation control part 603 determines whether the user has inputted the code to release the prohibition setting. When the code has been inputted, step S43 is proceeded to. When the code has not been inputted for a predetermined time, step S47 is proceeded to. For example, when the code has not been inputted for a predetermined time, it is processed as a timeout.

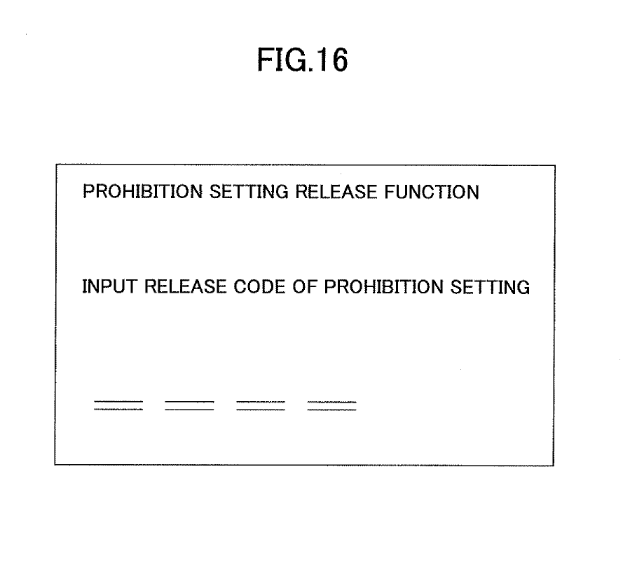

FIG. 16 illustrates one example of a release code input display of prohibition setting. The example illustrated in FIG. 16 is one example of releasing the prohibition setting by a code number. The display illustrated in FIG. 16 is displayed on the display 16, and four figures of code number are inputted by the user. The operation control part 603 sends to the lock release part 601 the inputted code number.

In step S73, the communication control part 602 sends to the first apparatus 5a the release notice of the prohibition setting including the release code, the prohibition release information and the identification data of an apparatus.

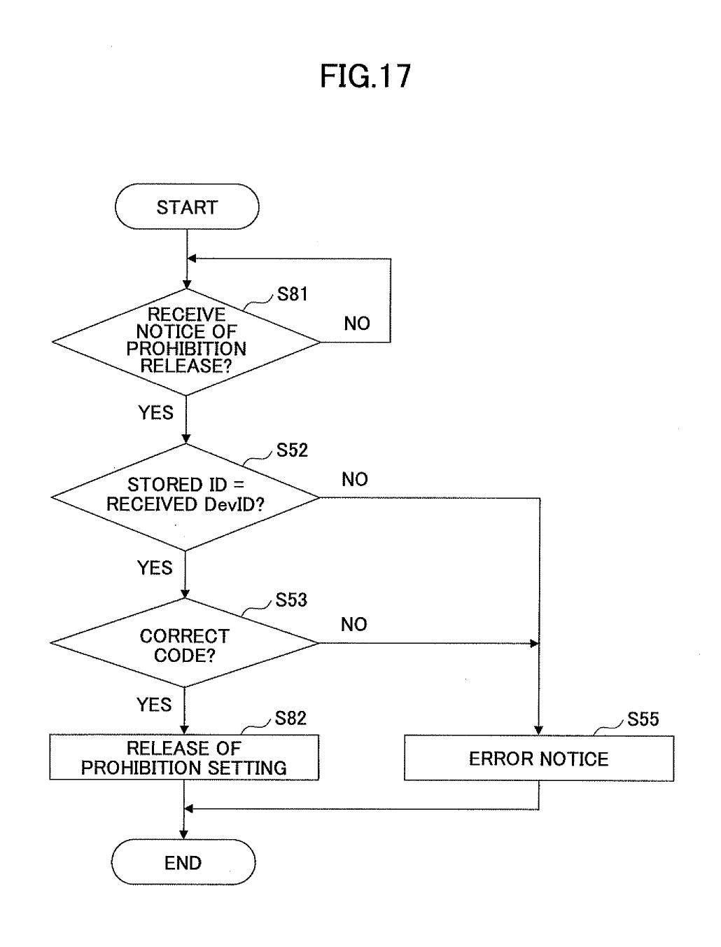

FIG. 17 illustrates a flowchart of one example of a release process of the prohibition setting of a first apparatus. Processes other than S81 and S82 are the same as those illustrated in FIG. 12.

In step S81, the communication control part 504 determines whether the release notice of the prohibition setting has been received from the second apparatus 5b. If the release notice includes the prohibition release information, the notice is determined as the release notice of the prohibition setting. When the release notice of prohibition setting has been received, step S52 is proceeded to. When the release notice of prohibition setting has not been received, step S81 is returned to.

In step S82, the lock release part 503 releases the lock of function that is set by the prohibition setting. Hereby, the first apparatus 5a may release the lock of the function that is set by the prohibition setting.

In the embodiment 3, one of requirements is an operation of another apparatus to restrict a function of own apparatus. Hereby, the lock of own apparatus is released from the other apparatus that operated last.

Next, a variant embodiment of each of the above-mentioned embodiments 1-3 will be described. It is possible to prepare a computer program for causing a mobile terminal to carry out the above-mentioned processes, install the program in the mobile terminal, and cause the mobile terminal to carry out the processes by causing the mobile terminal to execute the computer program.

A computer-readable storage medium stores the program which, when executed by a computer or a mobile terminal such as the controller 12 or the controller 22, causes the computer or the mobile terminal to perform the above-mentioned control processes. The computer-readable storage medium may be formed by any suitable medium capable of storing the program in a computer-readable manner, such as disks including magneto-optical disks, CD-ROMs, flexible disks, and semiconductor memory devices including flash memories and ROMs.

Further, the embodiments 1-3 may be applied to more than two apparatuses that communicate mutually. In this case, an apparatus that is operated sends to other apparatuses identification data of own apparatus.

All examples and conditional language recited herein are intended for pedagogical purposes to aid the reader in understanding the invention and the concepts contributed by the inventor to furthering the art, and are to be construed as being without limitation to such specifically recited examples and requirements, nor does the organization of such examples in the specification relate to a showing of the superiority or inferiority of the invention. Although the embodiments of the present disclosure have been described in detail, it should be understood that various changes, substitutions, and alterations could be made hereto without departing from the spirit and scope of the invention.

What is claimed is:

1. A communication terminal apparatus for communicating data, the communication terminal apparatus comprising:
a sending part configured to send, upon occurrence of an operation event, first identification data that identifies the communication terminal apparatus to another communication terminal apparatus which is in communication with the communication terminal apparatus;
a receiving part configured to receive, from the another communication terminal apparatus, second identification data that identifies the another communication terminal apparatus;
a memory part configured to store the first identification data upon occurrence of the operation event and the second identification data upon reception by the receiving part of the second identification data; and
a controlling part configured to prevent an operation locally performed on the communication terminal apparatus from changing a setting of a function of the communication terminal apparatus while the second identification data is stored in the memory part.

2. The communication terminal apparatus as claimed in claim 1, wherein the controlling part prevents releasing a functional restriction from the communication terminal apparatus while the second identification data is stored in the memory part.

3. The communication terminal apparatus as claimed in claim 1, the first identification data stored in the first memory part is updated to the second identification data upon reception by the receiving part of the second identification data when the communication terminal apparatus is in communication with the another communication terminal apparatus.

4. The communication terminal apparatus as claimed in claim 3, wherein the controlling part prevents updating identification data stored in the memory part when the communication terminal apparatus is not in communication with the another communication terminal apparatus.

5. A method for controlling a function in a communication terminal apparatus, the method comprising:
sending, upon occurrence of an operation event, first identification data that identifies the communication terminal apparatus to another communication terminal apparatus which is in communication with the communication terminal apparatus;
receiving from the another communication terminal apparatus second identification data that identifies the another communication terminal apparatus;
storing the first identification data upon occurrence of an operation event and the second identification data upon reception by the receiving part of the second identification data; and
preventing an operation locally performed on the communication terminal apparatus from changing a setting of a function of the communication terminal apparatus while the second identification data is stored.

6. A communication terminal apparatus for communicating data, the communication terminal apparatus comprising:
a receiving part configured to receive identification data that identifies another communication terminal apparatus, the identification data being sent from the another communication terminal apparatus upon occurrence of an operation event in the another communication terminal apparatus;
a memory part configured to store the identification data or data that denotes that the identification data has been received upon reception by the receiving part of the identification data; and
a controlling part configured to prevent an operation locally performed on the communication terminal apparatus from changing a setting of a function of the communication terminal apparatus while the memory part stores the identification data or the data.

7. The communication terminal apparatus as claimed in claim 6, wherein the identification data or the data, which is stored in the memory part, is deleted upon occurrence of an operation event in the communication terminal apparatus.
